(19) United States
(12) Patent Application Publication
(10) Pub. No.: US 2013/0066695 A1
(43) Pub. Date: Mar. 14, 2013

(54) SOCIAL NETWORKING AFFILIATE ADVERTISING REWARDS SYSTEM

(71) Applicant: Joseph P. Just, Glenview, IL (US)

(72) Inventor: Joseph P. Just, Glenview, IL (US)

(73) Assignee: Peak6 Investments, L.P., Chicago, IL (US)

(21) Appl. No.: 13/229,161

(22) Filed: Sep. 9, 2011

(51) Int. Cl. G06Q 30/02

(52) U.S. Cl. 705/14.16

(57) ABSTRACT

An electronic affiliate marketing system is disclosed that functions as a social networking affiliate advertising rewards (SNAARE) system in which rewards are provided to affiliates for selectively referring potential customers including social networking contacts, to a merchant's web site that allows the affiliate to selectively push multiple offers from one or multiple merchants and/or advertising/marketing firms (i.e., Groupon, Living Social, Amazon, etc. . . . ) to multiple parties and be paid rewards for all referrals that are derived from the initial referral. The electronic affiliate marketing system may optionally include a rating system for rating various parties based upon their previous purchasing history.

### BACKGROUND OF THE INVENTION

1. Field of the Invention

The present invention relates to an electronic affiliate marketing system and more particularly to a social networking affiliate advertising rewards (SNAARE) system in which rewards are provided to affiliates for selectively referring parties, including social networking contacts, to a merchant's or marketing/advertising firm (“merchant”) web site that allows the affiliate to selectively push one or multiple products and/or services (“offers”) from one or multiple merchants to one or multiple parties and be paid rewards for all referrals that are derived from the initial referral. The electronic affiliate marketing system may optionally include a rating system for rating various parties based upon their purchasing history.

2. Description of the Prior Art

Affiliate marketing systems are known in the art. Such affiliate marketing systems relate to marketing systems in which a merchant rewards (e.g. pays a commission) a third party for advertising or selling the merchant's products or services. One form of affiliate advertising relates to advertising on a web page. For example, an affiliate web page may include an advertisement, for example, a banner advertisement, illustrating an offer to purchase a merchant's products or services. Should a potential customer visit the affiliate web page and click on the advertisement, the potential customer is automatically re-directed to the merchant's web page. The potential customer is then provided with an opportunity to purchase the merchant's products or services available on the merchant's web site.

Some affiliate marketing systems pay rewards to an affiliate based upon “click throughs”, while other affiliate marketing systems pay rewards for actual purchases or specific “actions” (e.g., filling out and application). In each such system, the affiliate is required to pre-register with the merchant for a specific product offer. Both the affiliate and the specific product or service offers are assigned unique IDs. These unique IDs are used to keep track of the rewards due to the affiliates for each offer. In particular, when a potential customer clicks through to a merchant's web page and purchases a product or service, the potential customer is re-directed to a server (e.g., a server internal to the merchant or potentially with a third parting marketing/advertising firm) which keeps track of click throughs, actions and/or purchases that originate from each affiliate. In this way, the server is able to keep track of the rewards due to each affiliate.

Various systems are known which take advantage of affiliate marketing systems. One class of systems operates on a “deal of the day” business model. Such “deal of the day” systems offer a single type of product or service is for sale for a period of 24 hours. Various established retailers, such as Amazon.com and Buy.com feature “deal a day” items that allow affiliates to earn rewards (e.g., 3% of Sale—Baseline Commission.

Another organization that operates based upon a “deal of the day” business model is Groupon. Groupon is different than other retailers that operate on a “deal of the day” business model in that Groupon is not a retailer. In addition. Groupon offers a group coupon (“groupon”) each day for each market it serves. Groupon is unlike other retailers that operate on a “deal of the day” business model in that Groupon operates as an assurance contract. Specifically, if a certain number of customers agree to purchase the particular good or service offered for the day, the deal becomes available to all of the customers that have agreed to purchase. If less than a certain number of customers agree to purchase, the deal is not available.

In order to encourage and promote sales of products and services, entities that operate on a “deal of the day” business model take advantage of affiliate marketing systems, as discussed above. An affiliate is able to earn rewards based on click throughs and purchases that are derived from potential customers that click on the merchant ad on the affiliate web page. Although this method does encourage and promote sales, it has several drawbacks. One drawback is that the affiliate is paid a reward only for the first level of customers. In other words, if a visitor to an affiliate web page clicks on the merchant ad on that page and makes a purchase, the affiliate is paid a reward based upon the first purchase. However, if the customer forwards the offer to a subsequent party and the subsequent party makes a purchase, the affiliate is not compensated for that purchase. Second, while Groupon offers multiple products and services, in addition to their “deal of the day”, their refer-a-friend (affiliate) program is generic and lists all the groupons available in a specific city, for example “Chicago”, and offers only a one-time $10 if a friend purchases a Groupon (in Groupon Dollars).

In order to solve this problem and attract more affiliates in order to further promote sales, so called multi-level affiliate marketing systems have been developed. An example of such a system is disclosed in U.S. Pat. No. 7,917,402, hereby incorporated by reference. In such a system, the affiliate is paid a reward for all purchases that originated from the affiliate web page. Thus, using the example above, the affiliate would be rewarded for purchases by the subsequent party. However, in such a system, only a single offer can be pushed to the affiliate at a time. Moreover, if the affiliate decides to push the offer to third parties, the offer is pushed blindly to multiple parties even though many of the parties are unlikely to purchase based upon their previous purchase history.

In some known affiliate marketing systems, the recipient of an offer acts as the affiliate and is able to push the received offer to third parties, by way of social networking systems, such as Facebook and Twitter, or by way of email. For example, in a system, such as the Groupon system, receivers of the Groupon offer become affiliates. In particular, participants sign up for offers at the Groupon web site. A deal for a groupon is sent everyday to each participant that registers. As used herein a “groupon” is used to refer to a group coupon offered by Groupon. These affiliates have the ability to offer to purchase and/or push the offer to third parties by way of email or social networking systems.

Although, the Groupon system pays such affiliates rewards for pushing Groupon offers to third parties, there are several drawbacks to the system. For example, although such as system does provide some incentive for a recipient to push an offer to third parties, only one offer at a time can be pushed out by the affiliate at a time. Moreover, the Groupon system only allows offers that originate with Groupon to be pushed out and rewarded by Groupon. For example, offers by third parties, such as Living Social, cannot be pushed out through the Groupon system. In addition, Groupon allows offers to be blasted out to groups, for example, an email group that has previously been set up, such as a Microsoft Outlook group. Many affiliates are not likely to blast offers to groups because the members of the group are likely to become immune to such offers and respond by indiscriminately deleting or blocking such or offers and instead the affiliate will send the offer out offer to individual email contacts, which is cumbersome.

Thus, there is a need for an affiliate marketing system which solves the problems of the prior art and enables multiple product and/or service offerings to be selectively sent to social network contacts from multiple merchants.

### SUMMARY OF THE INVENTION

Briefly, the present invention relates to an electronic affiliate marketing system and more particularly to a social networking affiliate advertising rewards (SNAARE) system in which rewards are provided to affiliates for selectively referring parties, including social networking contacts, to a merchant's web site that allows the affiliate to selectively push multiple offers from one or multiple merchants (e.g., Groupon, Living Social, Amazon, Toyota, etc.) to multiple parties and be paid rewards for all referrals that are derived from the initial referral. Since the number of rewards paid to the affiliate is based on the number of product and/or service offers pushed out and the number of parties that the offer is pushed to, the system according to the invention will pay more rewards to affiliates, thus incentivizing the affiliates to push out more offers. The electronic affiliate marketing system may optionally include a rating system for rating various parties based upon their purchasing history. Most affiliates typically operate a pull system as opposed to a push system and use web sites that rely on potential customers searching for a product or service (pull). However, individual affiliates with intimate knowledge of the buying habits of people in their social network may be more successful at promoting products and services through their social network communications (push), but lack the skill and/or the time to set up a web site.

This invention envisions millions of individual affiliates promoting multiple product and service offerings quickly and easily though already established communication systems via their social network and being rewarded for each purchase that is made from the affiliate referral; thus creating both direct and indirect benefits to the economy. The direct benefits relate to the direct income provided to the affiliates. Ultimately this invention may provide a second income source for millions of individuals. The invention also creates an indirect benefit by creating jobs related to the additional products and services sold.

The SNARRE invention will provide greater relevance to customers, merchants and affiliates. Customers will find the ads more relevant because the offers they receive will be for products or services of interest to them. Merchants will have the benefit of their offers being sent to buyers with a higher probability of purchase. Affiliates will be incentivized by cash or other rewards.

In addition, the invention increases the relevance of affiliate advertisements by incentivizing consumers to open ads for products or services that may not even be relevant to the individual. For example, some products are gender specific, such as pedicures. Male consumers typically ignore ads for pedicures. Over time daily e-mails from companies such as Groupon are ignored if the majority of offers are irreverent. The average click through rate for a banner ad is known to be less than 1%. Groupon and similar companies face a similar problem with low open rates for their e-mails over time if the offers they present are irrelevant to their customers. Eventually these customers leave. Enhancing the customer experience by making them affiliates solves the problem. The present invention, SNAARE, will provide significantly higher click through rates and ultimately purchases for merchants by increasing the relevance of merchant advertisements by making customers into affiliates and rewarding them for providing value.

### DESCRIPTION OF THE DRAWING

These and other advantages of the present invention will be readily understood with reference to the following specification and attached drawing wherein:

FIG. 1 is a simplified diagram of a known affiliate marketing system

FIG. 2 is an exemplary illustration of a Groupon offer concept.

FIG. 3 is an exemplary diagram of alternate product offerings in accordance with the present invention

FIG. 4 is a simplified diagram of an exemplary user interface for the affiliate marketing program in accordance with the present invention.

FIG. 5 is a data flow diagram of the affiliate marketing program in accordance with the present invention.

FIG. 6 is a flow diagram that illustrates pushing multiple offers to one or more affiliates.

FIG. 7 is a flow diagram building a unique URL identifier.

FIG. 8 is a flow diagram that illustrates an exemplary purchase by way of the affiliate marketing program in accordance with the present invention.

FIG. 9 illustrates a flow diagram for an exemplary client application for pushing multiple offers to multiple parties over a social network.

### DETAILED DESCRIPTION

The present invention relates to an electronic affiliate marketing system and more particularly to a social networking affiliate advertising rewards (SNAARE) system in which rewards are provided to affiliates for selectively referring parties, including social networking contacts, to a merchant's web site that allows the affiliate to selectively push multiple offers from one or multiple merchants and/or advertising/marketing firms (e.g. Groupon, Living Social, Amazon, Toyota, etc.) to multiple parties and be paid rewards for all referrals that are derived from the initial referral. The electronic affiliate marketing system may optionally include a rating system for rating various parties according to their purchasing history.

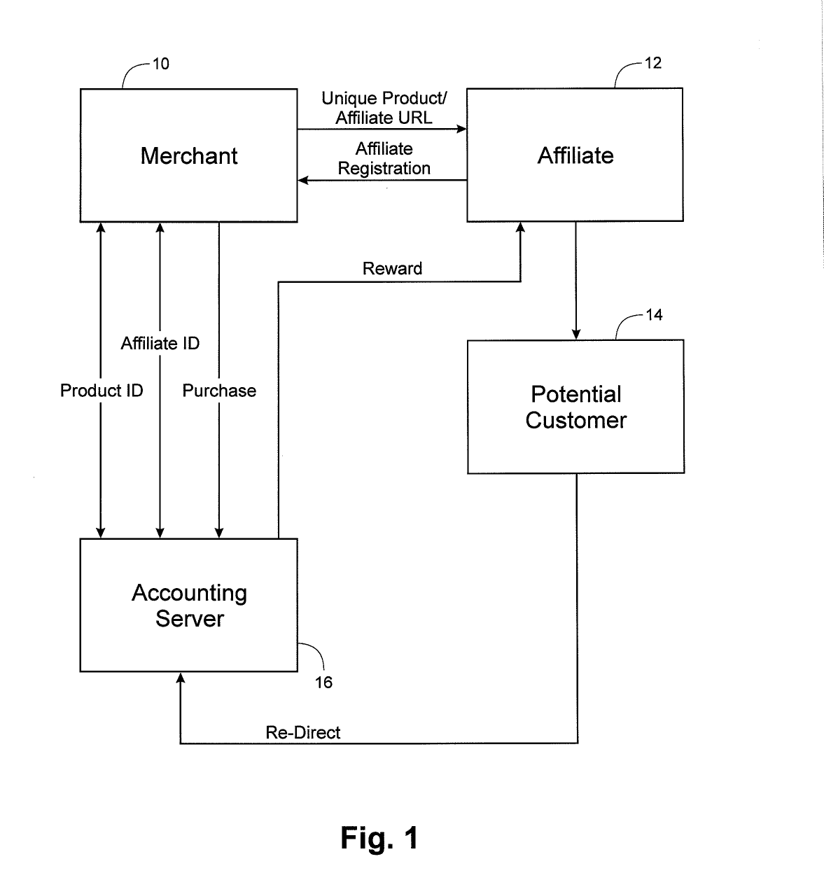

As will be discussed in more detail below, the present invention is an improvement on existing affiliate marketing systems. Referring to FIG. 1, a simplified diagram of known affiliate marketing systems is shown. A merchant, identified with the reference numeral 10, offers a product or service (collectively or individually referred to as an “offer” or “offering”) to an affiliate 12. In this example, the affiliate 12 first registers with the merchant 10 or the merchant's agent (e.g., marketing/advertising firm) and is assigned a unique affiliate ID. The offer is also assigned a unique ID by the merchant 10 or the merchant's agent. These IDs are then embedded in a unique offering URL (uniform resource locator) and directed to the affiliate 12. When a customer 14 clicks on an affiliate's 12 text link or banner ad on an affiliate web site, the customer 14 is first transparently re-directed to an accounting server 16 via the URL embedded in the text link or banner ad. Since the URL, available at the affiliate web site for purchasing an offering, is embedded with a unique product ID and a unique affiliate ID, the accounting server 16 is able to keep track of the offerings and affiliate IDs associated with the offers. The accounting server 16 then transparently re-directs the customer's web browser to the merchant's web site to complete the purchase or click through transaction. The Merchant 10, after a purchase or action, sends an electronic file to the accounting server 16 which includes the product ID, affiliate ID and reward amount for the affiliate 12.

The accounting server 16 may be hosted separately from the merchant 10, as shown by a third party, such as, Commission Junction. Alternatively, the accounting server 16 may be hosted by the merchant 10.

The principle of the present invention apply to various affiliate marketing systems associated with various types of marketing systems including the affiliate marketing system illustrated in FIG. 1. Indeed, the invention is described and illustrated with respect to a specific type of affiliate marketing system as it applies to marketing business model, known as the “deal of the day”. However, the principles of the invention are not so limited.

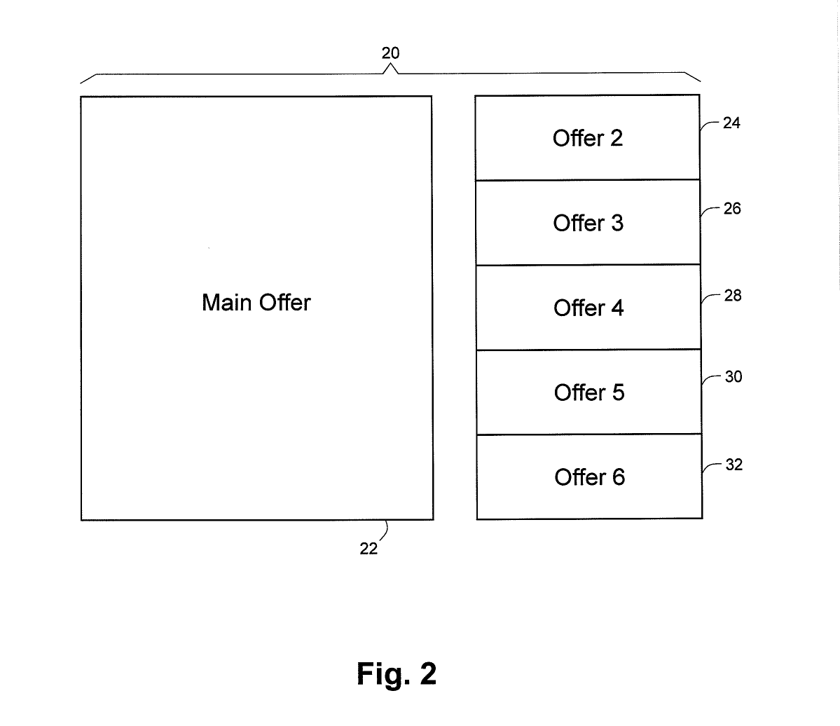

An exemplary “deal of the day” marketing system is described and illustrated in FIG. 2. In particular, a Groupon offer concept is illustrated in FIG. 2. Visitors to the Groupon web site that sign up for deals and provide their email, Facebook or Twitter address to Groupon are provided with a deal of the day. In the exemplary offer, illustrated in FIG. 2, the deal of the day is presented by way of an email, Facebook or a Twitter message, daily or as desired.

An exemplary Groupon offer is shown and identified with the reference numeral 20. The Groupon offer 20 includes a main offer 22 and a plurality of alternate offers, identified with the reference numerals 24, 26, 28, 30 or 32. A participant is provided with an opportunity to accept the main offer 22 and/or purchase any of the alternate offers 24, 26, 28, 30 or 32. Each offer 20 includes a description of the products or services being offered; the price at which the products or services are being offered and the time left to buy the particular offer. Various other information regarding the deal is also provided, such as whether the “deal is on” and the total number of offers purchased so far. With the Groupon system, a certain number of offers have to be purchased before the deal is available, i.e. “the deal is on”.

The main offer 20 includes a “BUY” button (not shown) that when selected allows the recipient of the offer to buy the Groupon for the product or service that is offered. The recipient of the deal of the day may also become an affiliate. More particularly, at the bottom of the offer 20 is a “Share” box (not shown). The “Share” box allows the offer to be shared with third parties by way of social networking systems, such as Facebook or Twitter, or by email. In order to encourage recipients of the offers to push the offers to third parties, the recipients are paid a reward when the third parties purchase a Groupon. Unfortunately, only one deal can be pushed to third parties at a time. More particularly, even though Groupon lists alternate offers 24, 26, 28, 30 and 32, identified in FIG. 2 as “Offer 2”, “Offer 3”, etc., only one offer is presented at a time. In addition, the offer can only be pushed to one party or a predetermined group at a time. For example, if the deal is pushed by email, the third party recipient's email addresses either have to be individually loaded in the email or an email group has to be created beforehand and the offer sent out to a group. Unfortunately, not all members of the group may be interested in the offer.

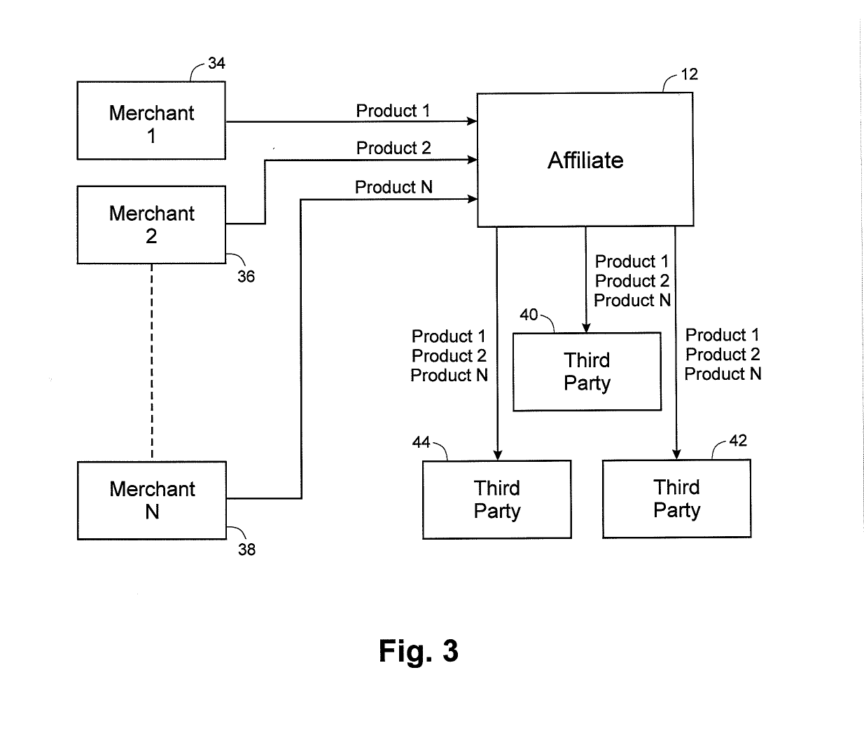

The present invention solves these problems and allows an affiliate to selectively and simultaneously push out multiple offers to multiple parties quickly and easily. A simplified diagram of an application of the present invention is illustrated in FIG. 3. In accordance with an important aspect of the invention, an affiliate 12 is able to simultaneously push out offerings from virtually any number of merchants (e.g., Groupon, Living Social, Amazon, Toyota, etc. . . . ) 34, 36 and 38, identified as, Merchant 1, Merchant 2 . . . Merchant N. As shown, each merchant, Merchant 1, Merchant 2 . . . Merchant N, is associated with a single product, Product 1, Product 2 . . . Product N, respectively. However, the principles of the present invention are also applicable to applications in which one or more merchants are associated with more than one product. Another important aspect of the invention is that the affiliate 12 is able to selectively push out one or more offers, identified as Product 1, Product 2 . . . Product N, to multiple third parties 40, 42 and 44, respectively.

In the present invention, the affiliate is paid a reward for all purchases or click throughs by third parties 40, 42 and 44. As such, an affiliate 12 is able to earn more rewards than known affiliate marketing systems. Statistically, the more offers pushed out to third parties should result in relatively more rewards to affiliates 12, which providing significantly more incentive to the affiliate 12 to selectively and continuously push out as many offers as possible. In known systems, such as the Groupon system, the affiliates in the Groupon system are individuals. After a period of little to no rewards, these individuals may be left with little incentive to continue pushing out offers. On the other hand, the present invention will provide more rewards more frequently, thus significantly increasing the incentive for affiliates to push offers out.

Another important aspect of the invention is that the offers can be selectively pushed to multiple parties. As discussed above, known systems, such as Groupon, allow an offer to be pushed out to individual parties or a predetermined group of parties. The group, as used in the Groupon system, would have to be group formed in the affiliates email system, such as Microsoft Outlook. These groups would be cumbersome to form. If the group was formed with common interests, for example, all contacts that are fisherman, the group would constantly require changing as new contacts are being added and existing contacts opt out of the group. As will be discussed in more detail below, the present invention solves this problem by allowing an affiliate to selectively push one or more offers to one or more parties.

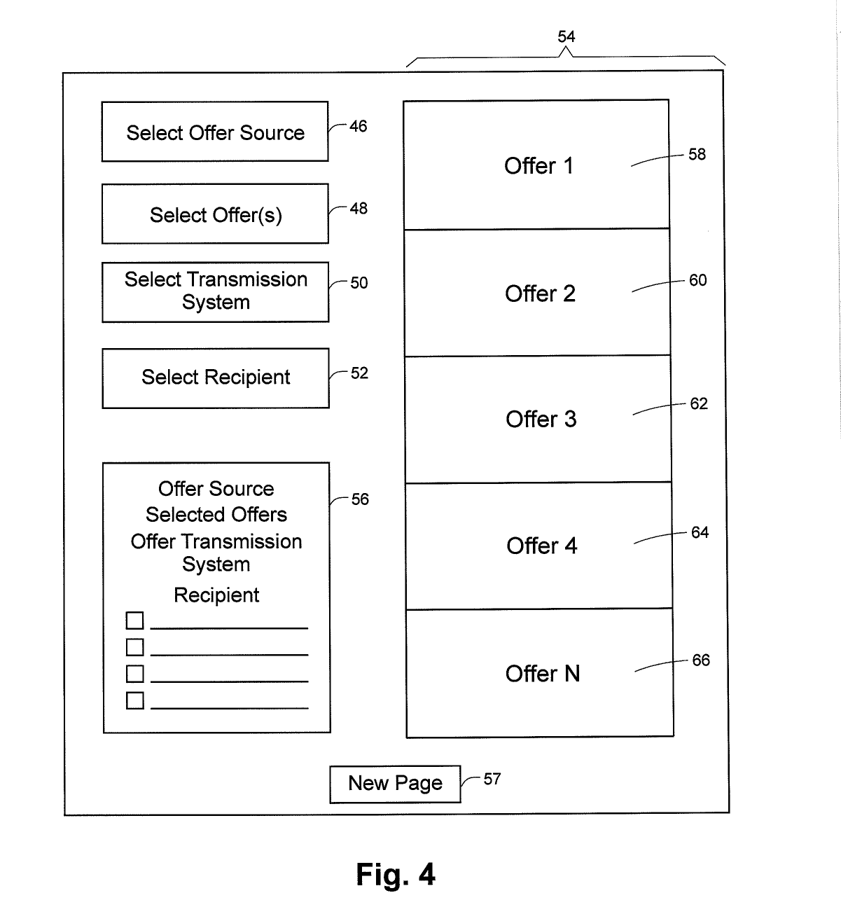

An exemplary user interface for the present invention is illustrated in FIG. 4. As shown, the user interface may be provided with four (4) drop down menus 46, 48, 50 and 52. The user interface may also include an offer display 54 of all of the offers selected by the affiliate 12 and a text box 56 illustrating various third parties that can be selected by the affiliate 12 to receive one or more of the offers 58, 60, 62, 64 and 66 for OFFER 1, OFFER 2 . . . OFFER N.

An exemplary method of operation is described below. Assuming that the affiliate receives one or more deals from multiple deal sources, the affiliate 12 first selects a deal source by way of the “Select Deal Source” button 46. When the affiliate 12 selects of the “Select Deal Source” button 46, the deals associated with one particular merchant are displayed in the offer display 54. Next, the affiliate click on a particular offer 58-66

The “Select Transmission System” Mode button 50 allows for various transmission systems to be utilized for transmitting the offer to various third parties. For example, the transmission systems may include various options for transmission systems, such as, native, email, Facebook, Twitter, etc. Native refers the address of recipient as it saved on the affiliate's computer. In order to facilitate the operation, the system accesses the affiliate's email address book, Facebook, Twitter, etc. accounts and grabs the names and electronic addresses for the selected recipients and stores them in a native address file. The names from the native file are used to populate the text box 56. Thus, in the native transmission mode, one or more offers 58-66 can be pushed to any recipient on the recipient display 56, regardless of the transmission system used to reach that applicant, whether it is email or a social network.

Other transmission modes include social networking networks, such as Facebook, Twitter, etc. Transmitting offers by way of social networks is known in the art. Examples of such systems are disclosed in US Patent Application Publication Nos. US 2008/0172344; US 2010/0125490; US 2010/0241576 and US 2010/0287282, hereby incorporated by reference.

If a social networking mode is selected, such as Facebook, then all of recipients from the native file from the affiliate's Facebook account may be selected to populate the text box 56. The affiliate will still have the ability to selectively send the offer to selected recipient's by checking the check box next to the recipient's name. This feature allows an affiliate to send out more offers and to send out an offer by multiple transmission modes. In other words, an affiliate can simultaneously send out one or more offers by email and by way of social networks. By paring offers with selected recipients, the potential for rewards is increased and the number of nuisance offers sent to recipients is reduced, since such nuisance offers can easily result in offers being blindly rejected.

Once a particular Transmission System Mode is selected, the affiliate 12 can select the “Select Recipient” button 52. Selection of the “Select Recipient” button 52 populates text box 56 with potential third party recipients. The affiliate can simply check the check box next to each recipient's name to cause the offer to be sent to a recipient. Additional selections can be made by selecting a “New Page” button 57.

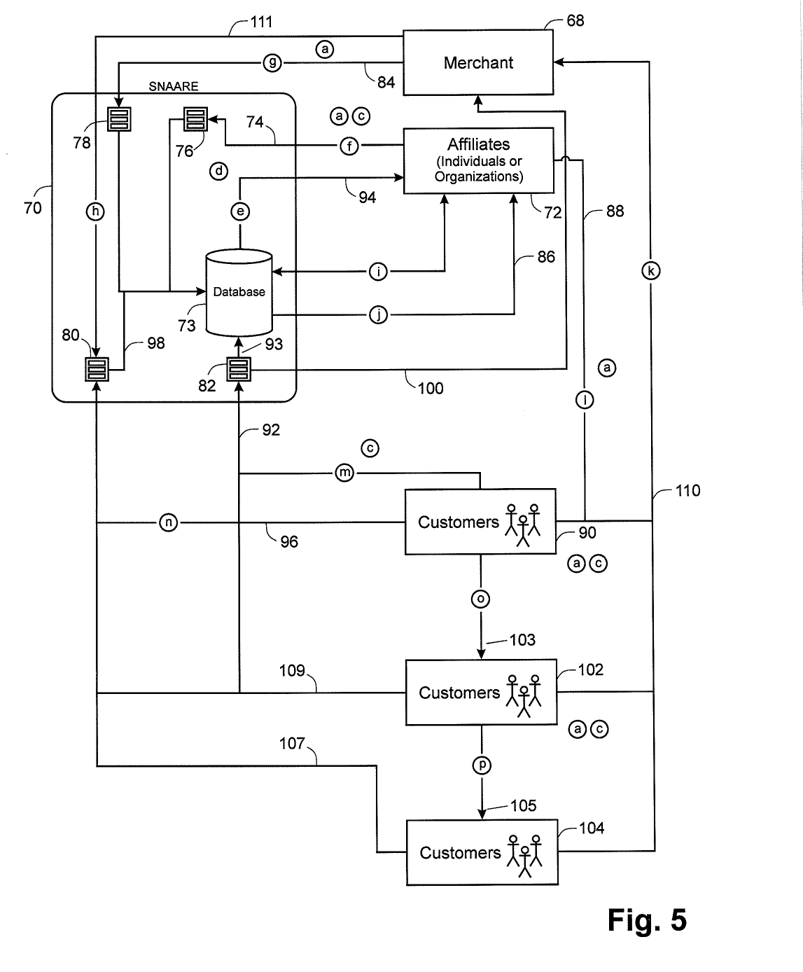

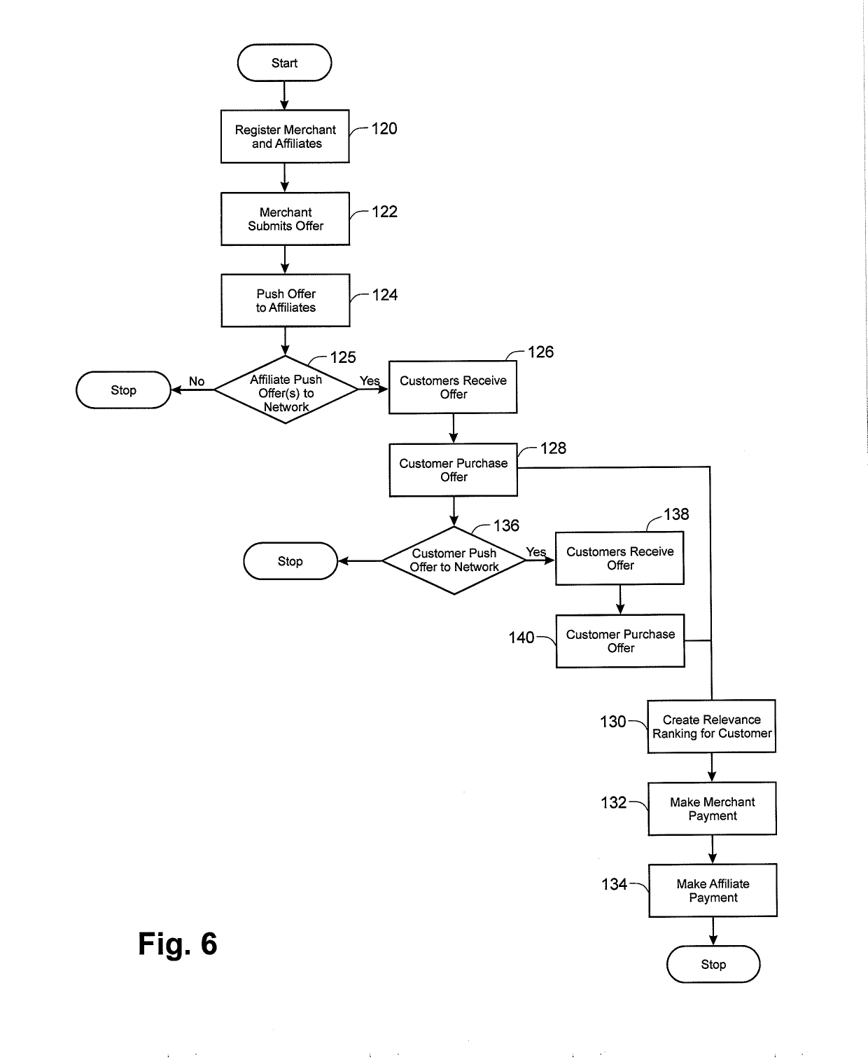

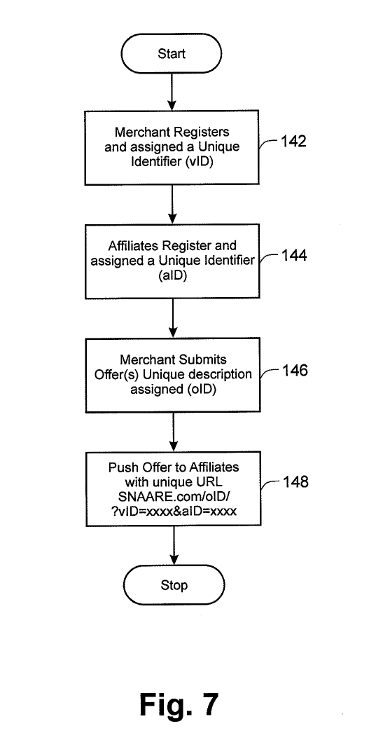

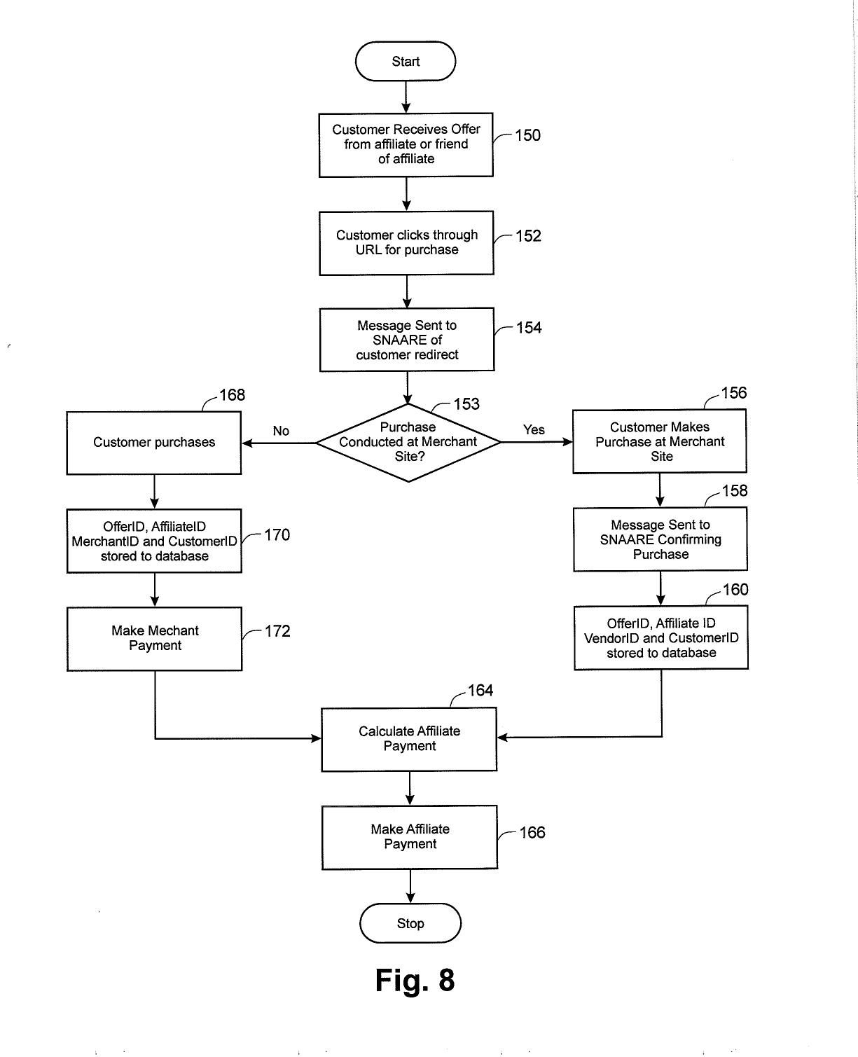

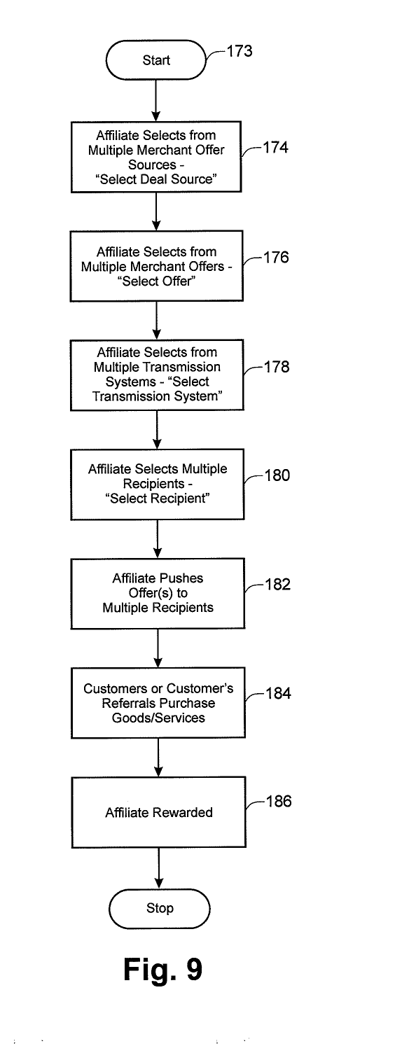

In exemplary system for the present invention is illustrated in FIGS. 5-9. FIG. 5 is an overall data a flow diagram of the SNAARE marketing program in accordance with the present invention. FIG. 6 is a flow diagram that illustrates the process that allows the affiliate to selectively push one or multiple product and/or service offers from one or multiple merchants to one or multiple parties and be paid rewards for all referrals that are derived from the initial referral. FIG. 7 is a flow diagram that illustrates the building a unique identifier. FIG. 8 is a flow diagram that illustrates an exemplary purchase by way of the affiliate marketing program in accordance with the present invention. FIG. 9 illustrates a flow diagram for an exemplary client application for pushing multiple offers to multiple parties over a social network.

Referring first to FIG. 5, a merchant, such as Groupon, is illustrated within the box 68. In this example, the system in accordance with the present invention can be configured as a “back office” system. In other words, instead of offers being pushed directly to customers, for example, as in the Groupon system, discussed above, offers may be pushed or pulled to the social networking affiliate advertising rewards (SNAARE) system 70. The SNAARE system 70 includes a non-transitory data storage device 73 for storing a database and may include other data storage devices for storing data other than the database (collectively and individually referred to as a “data storage device”) and one or more servers, 76, 78 and 80 that each includes one or more processors (the processors and servers collectively and individually referred to as “processor” or a “processing system”). In this system, affiliates 72 register with the SNAARE system 70, as indicated by the line 74. In particular, affiliates 72 may register by way of a web interface (not shown). Once registered, the processing system creates a unique ID (identification) for each affiliate. In a similar fashion, each merchant 68 also registers with the SNAARE system 70, as indicated by the line 84. A unique ID is created for each offer by way of the processing device 78. The unique affiliate ID and the unique product ID are stored in the data storage device 73 and are used by the processing device 80 to create a unique URL for the offer in which the unique affiliate ID and the unique offer ID are embedded, as indicated by line 98. The unique URL is stored in the data storage device 73. The offer along with the unique URL is pushed to the affiliate 72, as indicated by the line 86. In accordance with an important aspect of the invention, the SNAARE system 70 allows multiple offers from multiple merchants 68 to be pushed to an affiliate 72.

As indicated by the line 88, the affiliate 72 can then selectively push each offer to a first level customers 90 using email or social networks, as discussed above. Each offer includes a URL that includes the unique affiliate ID and the unique product ID and transparently directs the customer 90 to the SNAARE system 70 where rewards are calculated based upon the affiliate's ID and offer ID and credited to the affiliate. Thus, when a customer 90 clicks through to a merchant 68 website, the customer 90 is transparently routed to the SNAARE system 70, where the affiliate ID and product offer ID is stored in the data storage device 73, as indicated by lines 92 and 93.

In order to complete the purchase or click through, the SNAARE system 70 transparently re-directs the customers, as indicated by the lines 96, 107 and 109 to the merchant 68, as indicated by the lines 92 and 100, by the processor 82. The data storage device 73 includes the URL of the purchase or click through to the merchant 68, as indicated by the line 93. The merchant 68 stores the unique URL that includes the unique affiliate ID and the unique product ID and would transmit purchase information electronically to the SNAARE system 70, as indicated by the line 111, which would calculate the reward for the affiliate 72. The processing device 82 computes the rewards due the affiliate 72 based on the purchase or click through and credits the affiliate's account, as indicated by the line 94. Other accounting functions associated with the purchase may also be handled by the SNAARE system 70, such as determining the aggregate rewards paid to an affiliate 72 during a particular period for tax purposes.

If a customer redirects after their initial click through to another web site, but within a designated time period as defined by the merchant 68 in the SNAARE system 70, and purchases goods or services from the merchant 68 directly, as indicated by line 110, an affiliate 72 will still eligible for rewards.

In accordance with another aspect of the invention, rewards may be paid to an affiliate for all vertical sales of the offer. For example, if any of the customers 90 to which the affiliate 72 referred the offer, i.e. tier 1 customers 90, in turn, refer the offer to any second tier of customers 102, i.e. tier 2 customers, as indicated by the line 103, the affiliate 72 can earn rewards for purchases or click throughs by such tier 2 customers. Similarly, if any of the tier 2 customers 102 refer the offer to a third tier of customers, i.e. tier 3 customers 104, as indicated by the line 105, the affiliate 72 can earn rewards for purchases or click throughs by such tier 3 customers. The URLs for the tier 2 and tier 3 customer purchases will have the embedded affiliate ID and the offer ID embedded in the URL. As mentioned above, the purchase or click throughs by the tier 2 and tier 3 customers will direct the customers initially to the SNAARE system 70, as indicated by the lines 107 and 109, where the affiliate's account is credited. The tier 2 and tier 3 customers are then re-directed to the merchant's web site 68 to complete the purchase, as indicated by the line 100 or line 110 if they come back at a later time to purchase.

The three (3) customer tiers shown are merely exemplary. The rewards system for enabling an affiliate to earn rewards for vertical sales is applicable to virtually any number of customer tiers. Systems with more than three (3) customer tiers will operate in a similar manner as the three (3) tier system described and illustrated.

Referrals to the customers are discussed above. Referrals from the customers may be by email or by way of a social network, such as Facebook, Twitter, email, etc. The offers may be pushed out by affiliates and customers as discussed in US Patent Application Publication Nos. US 2008/0172344; US 2010/0125490; US 2010/0241576 and US 2010/0287282, hereby incorporated by reference, discussed above.

FIGS. 6-8 illustrate exemplary flow diagrams for the SNAARE system 70. Please note the flow diagrams do not indicate a particular sequence for the steps performed. Referring first to FIG. 6, this flow diagram illustrates how the SNAARE system 70 pushes multiple offers to one or more affiliates 72. Initially, as indicated in box 120, the system registers merchants 68 (FIG. 5) and affiliates 72. As shown in block 122 (FIG. 6), the SNAARE system 70 registers offers. As discussed above and in more detail below, unique IDs are created for the offers and the affiliates 72 which are embedded into a URL. Once the merchants 68 and product offers are registered, i.e. stored in the data storage device 73 (FIG. 5), the offers are pushed out 124, i.e. sent to affiliates 72 or affiliates 72 can log directly into the SNAARE system to see all offers from various Merchants 68. Once the offer is pushed by an affiliate to a social network 125 and assuming that the customers receive and purchase the offer as indicated by the blocks, 126 and 128, the system is able to create a customer relevance ranking 130 for the customer. This customer relevance ranking can be used to aid in deciding which customers to send offers to in the future. This customer relevance ranking 130 can be added to the information displayed on the user interface discussed and illustrated in connection with FIG. 4 or alternatively, the SNAARE system 70 can automatically send the offers to customers that meet a certain relevance criteria.

Various techniques can be used for creating a customer relevance ranking. One technique would be to assign each customer a point each time the customer purchases or completes a click through for a specific type of product (i.e., hair removal). Customers with a certain number of points are automatically or manually sent future offers for similar products or services, a category of products or services, or all offers. Initially, all customers would be sent offers until a sufficient amount of relevance data is collected. For example, relevance data could be collected from a sample customer base for 10 offers. Customer data can be collected by recording customer IP addresses in the database when customers purchase or complete a click through and points can be assigned for each purchase or each dollar spent by the customer. Alternatively, the customer's relevance ranking could be based on the number of times the customer purchases or completes a click through as a function, for example, a percentage, of the number of offers sent to customer.

Purchases may also be made directly through the SNAARE system 70. FIGS. 6-9 illustrate that the SNAARE system 70 may collect payments from the customer, as opposed to the merchant 68 collecting the payment and notifying the SNAARE system 70 of the payment, as indicated in line 111. Once the payment is made, the SNAARE system 70 credits the merchant 68 and the affiliate 72, as indicated by the boxes 132 and 134 for the purchase.

The system operates in a similar manner for offers pushed by customers, i.e., tier 1, tier 2 and tier 3 customers. In this scenario, assuming the customers receive and purchase offers, as indicated by the boxes 136, 138 and 140, the system updates the appropriate relevance ranking for the customers and credits the merchant 68 and affiliate 72 for the purchase.

FIG. 7 is a flow diagram building a unique URL identifier. As indicated by the blocks 142, 144 and 146, the merchant 68, product or service offer 84 and the affiliate 72 all register with the SNAARE system 70. The SNAARE system 70 creates unique IDs that are embedded in a unique URL. In one embodiment, unique IDs are created for the product or service offer 84 and the affiliate 72. In this embodiment, the product and service offers 84 are associated with the merchant 68 during registration and stored in the data storage device 73. In this embodiment, a unique URL is generated by the SNAARE system 70 that embeds the affiliate ID and the product offer ID. The URL directs the customer to the SNAARE system 70 for accounting purposes where the customer is redirected to the merchant 68 web site. Alternatively, unique IDs can be created by the SNAARE system 70 for the affiliate 72, the merchant 68 and product offer 84.

FIG. 8 is a flow diagram that illustrates an exemplary purchase by way of the affiliate marketing program in accordance with the present invention. As mentioned above, purchases can be processed by either the merchant 68 or the SNAARE system 70. The blocks 154-160 represent an embodiment in which purchases are made at the merchant 68 web site and processed by the SNAARE system 70, while blocks 168-172 represent an embodiment in which purchases are handled by the SNAARE system 70. In both embodiments, the SNAARE system 70 calculates reward payments to the affiliates 70 and credits the affiliate's account, as indicated by the blocks 164 and 166.

In the first embodiment in which the customer purchases directly at the merchant 68 web site, as indicated by the blocks 153 and 156, as indicated above, the unique URL initially directs the customer to the SNAARE system 70 where the offer ID, affiliate ID and in some embodiments, the merchant ID is stored in the data storage device 73 (FIG. 5). The customer is then redirected to the merchant web site to make the purchase. Once the purchase is made, the merchant web site is configured to send a confirmation to the SNAARE system 70 that the purchase has been completed, as indicated by the block 158. This confirmation includes the customer ID available from the purchase transaction and the offer ID. This information is stored in the data storage device 73 by product offer, affiliate offer and merchant 68, as indicated by the block 160. Rewards are calculated and paid to the affiliate, as indicated by the blocks 164 and 166, discussed above. The offer ID and customer ID are used to determine the customer relevance ranking, as discussed above.

Alternatively, the SNAARE system 70 handles all payment processing. In this embodiment, the customer is directed to the merchant web site is configured to direct the customer to the SNAARE system 70 to complete the purchase, as indicated by the block 168. The offer ID, merchant ID and affiliate ID is stored in the data storage device 73 (FIG. 5) along with the customer ID and purchase data, as indicated by the block 170. The purchase is credited to the merchant's account, as indicated by the block 172. The customer ID is available from the purchase transaction. The purchase data and customer ID is used to develop the relevance ranking discussed above.

FIG. 9 is flow chart for an exemplary client application for pushing offers to multiple parties over a social network. Initially in step 173, the affiliate logs on to the SNAARE system 70 on a client device, such as a personal computer or smart phone. Once logged in, the SNAARE system populates the display of the client device as illustrated in FIG. 4. In step 174, selects the “Select Offer Source” button 46 on the display causing the selected offer source, for example, Groupon, Living Social, etc., to be posted in the text box 56. Next in step 176, the affiliate selects one of the offers 58-66 by selecting the “Select Offer” button 48 and clicking on one or more of the offers 58-66. The selected offer(s) are displayed in the text box 56 along with the offer source. In step 178, the affiliate selects a transmission system, such as Facebook, Twitter, email, etc. by selecting the “Select Transmission System” button 50. The “Select Transmission System” button 50 may be figured as a toggle button so that each time the “Select Transmission System” button 50 is clicked on a different transmission system, e.g. Facebook, Twitter, Email, etc., is displayed in the text box 56. Next in step 180, the affiliate selects the “Select Recipient” button 52. Once the affiliate selects the Select Recipient” button 52, the system populates the text box 56 with recipients and check boxes next to the check boxes. These recipients may be selected from social network and email contact lists available on the affiliate client device. In order to push the selected offer to a recipient, as indicated in step 182, the affiliate simply checks the check box next to the recipient's name. The SNAARE system 70 pushes the selected offer by the selected transmission system to the selected recipients 182. In order to push other offers, for example, to a different group of recipients, the affiliate merely selects the “New Page” button 57 and repeats steps 174-182.

If the recipients decide to purchase the goods or services indicated in the offer, as indicated in step 184, either directly or indirectly through the merchant 84 or the SNAARE system 70, the affiliate account is subsequently credited a reward for the purchase in step 186.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. An affiliate marketing system comprising:
a non-transitory data storage device for storing data;
at least one processor system including at least one processor programmed to handle the following steps:
(a) receive affiliate registrations and product offer registrations;
(b) create a unique universal resource locator (URL) based upon said affiliate registrations and said product or service offer registrations;
(c) enable multiple offers to be selectively pushed to one or more affiliates at the same time;
(d) keep track of purchases or other actions by customers based upon said offers that are pushed by said affiliates; and
(e) credit rewards to affiliates for purchases or other actions by said customers of said offers pushed by said affiliates.

2. The affiliate marketing system as recited in claim 1, wherein said processor is programmed to push out multiple product or service offers from multiple sources at the same time.
